(19) United States
(12) Patent Application Publication
(10) Pub. No.: US 2011/0081631 A1
(43) Pub. Date: Apr. 7, 2011

(54) Lifeboat Simulator

(75) Inventors: Peter Iain Henderson, Bridge Of Don Aberdeenshire (GB); Raymond Allen, Bridge Of Don Aberdeenshire (GB)

(73) Assignee: PISYS LIMITED, Bridge Of Don Aberdeenshire, GB (GB)

(21) Appl. No.: 12/922,169

(22) PCT Filed: Mar. 13, 2009
(86) PCT No.: PCT/GB09/50243

§ 371 Date: Dec. 4, 2010

(30) Foreign Application Priority Data
Mar. 13, 2008 (GB) 0804658.3

(51) Int. Cl. G09B 9/02

(52) U.S. Cl. 434/29

(57) ABSTRACT

A lifeboat simulator comprises a cabin (12) which may be large enough to enclose a plurality of people, along with a support mechanism (22, 24, 30) whereby the cabin can undergo at least limited rotational movement around its longitudinal axis, and can accelerate upwards and downwards, and can undergo pitch movements, all these movements being driven by one or more motors (26, 36).

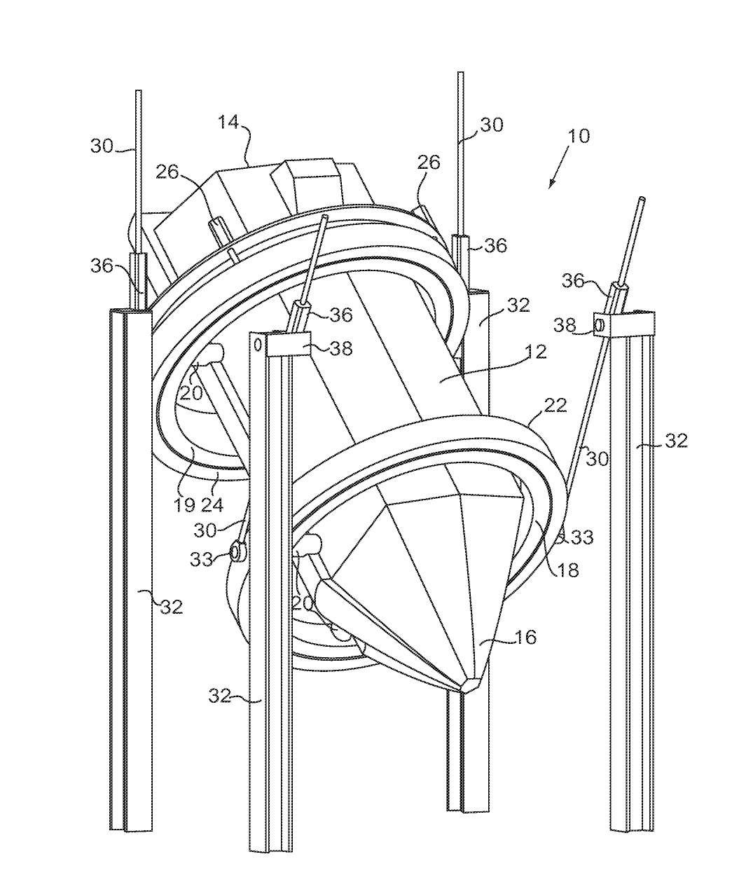

The present invention relates to a simulator of a lifeboat.

The use of simulators for training users of complex equipment is well-known. For example aircraft cockpit simulators (flight simulators) have been used for many years, in which a trainee experiences many of the movements that he would be subjected to in a real aircraft cockpit; for example if the trainee moves the joystick, the orientation of the simulator moves to simulate the effect on a real aircraft.

Lifeboats are normally lowered, suspended on cables, down to the sea; such lifeboats are in widespread use on ferries and liners. However for some purposes, particularly where rapid deployment is required, it is known to launch a lifeboat from a ship or platform using a launching ramp, so that the lifeboat undergoes freefall before impacting with the sea. This type of lifeboat system is particularly suitable for use on oil wells or oil producing platforms in the sea. The users of such a lifeboat system, for the sake of safety, would be secured by harnesses or seat belts before the lifeboat is launched. Nevertheless the movements experienced during such a launch, including rapid accelerations and decelerations, rolling, pitching and yawing, can be very upsetting even for trained crew, and can lead to motion sickness. For example the lifeboat may temporarily roll upside down. It has been known for the crew, in such situations, to then act in ways which are dangerous to themselves, for example opening hatches before the lifeboat has righted itself. It would be desirable to be able to train crew as to the sort of movements that they may experience during such a launch.

According to the present invention there is provided a lifeboat simulator, comprising a cabin to enclose at least one person, the cabin having a longitudinal axis, and the simulator comprising a support mechanism whereby the cabin can undergo at least limited rotational movement around its longitudinal axis, and can accelerate upwards and downwards, and can undergo pitch movements, all these movements being driven by one or more motors.

Preferably the support mechanism also includes means to subject the cabin to yawing movements.

The lifeboat simulator may comprise two spaced apart support frames which surround the cabin at different positions along its length and enable the cabin to undergo at least limited rotational movement about its longitudinal axis; and support pillars provided with variable-length linkages to support the support frames, to enable the cabin to be subjected to accelerations in the upward or downwards direction, and to subject the cabin to pitching movements.

The variable-length linkages may themselves be flexible, such as wire cables, or may comprise one or more rigid elements linked together and provided with pivotal connections. For example the linkage may utilise a threaded shaft connected to the respective support frames by a pivot, and connected to the respective support pillar by a universal joint, and provided with a drive mechanism on the support pillar.

The rotational movement of the cabin about its longitudinal axis may be brought about by one or more motors within the support frames. Changes in the length of the variable-length linkages may be achieved by one or more motors either on the support frame or on the support pillar. Such motors may be electric motors or hydraulic motors, for example. It should also be appreciated that the simulator may also include means to damp movements of the cabin, so as to suppress oscillatory movements.

Preferably the cabin is large enough to accommodate several people, as that is normally the case for lifeboats.

The invention will now be further and more particularly described, by way of example only, and with reference to the accompanying drawing, in which the figure shows a perspective view of a lifeboat simulator of the invention.

As shown in the figure, a lifeboat simulator 10 comprises a cabin 12 inside which are several fixed seats provided with restraint harnesses (not shown). People who are to use the lifeboat simulator 10 have access to the inside of the cabin 12 through a hatch 14 at one end of the cabin 12 (which may be referred to as the stern). The other end 16 of the cabin 12 (which may be referred to as the bow) is of a generally conical shape, so that the appearance of the inside of the cabin 12 is that of the inside of a lifeboat.

The cabin 12 is rigidly connected to two inner support rings 18 and 19 by three radial struts 20 (only some of which are visible). The inner support ring 18 nearer the bow can rotate freely within a bow support ring 22; the inner support ring 19 nearer the stern can rotate freely within a stern support ring 24, and on the inner support ring 19 are motors 26 to bring about this rotational movement. Each of the bow and stern support rings 22 and 24 is supported by a pair of threaded shafts 30 linked a respective support pillar 32, there being two support pillars 32 on each side of the cabin 12. Each shaft 30 is connected at one end to the bow or stern support ring 22 or 24 at a pivot 33 (only those on the bow support ring 22 being visible) and extends up to a motor 36 at the top of one of the pillars 32. The motors 36 that are linked to the bow support ring 22 are mounted on gimballed mounts 38. In this example the motors 36 are actuated in pairs: one pair are those linked to the bow support ring 22, and the other pair are those linked to the stern support ring 24.

Hence activation of the motors 26 enables the cabin 12 to be rotated about its longitudinal axis. Simultaneous and equal activation of both pairs of motors 36 enables the cabin 12 to be moved vertically up or down, while activation of one pair of motors 36 differently from the other pair of motors 36 enables the cabin 12 to be subjected to pitching movements, for example as shown with the bow markedly lower than the stern.

In use of the lifeboat simulator 10, the cabin 12 would initially be set up in the orientation of a lifeboat on a ramp, which would normally require that the bow is lower than the stern. In this initial position the people to be trained would enter the cabin 12 through the hatch 14, and secure themselves to the seats with the harnesses. To initiate a simulated launch the pairs of motors 36 would then be actuated to give the people in the seats the impression that the cabin 12 is accelerating down the ramp and then falling onto the sea. This might for example involve first raising the bow (to give the impression of forward acceleration of a lifeboat), and then rapidly lowering the entire cabin (to give the impression of freefall), and then very rapidly raising the entire cabin and tipping the bow down (to give the impression of the deceleration of the lifeboat on impact with the sea), and then actuating the motors 26 to rotate the cabin 12 through say 120° , and then rotating back to say 80° the opposite direction, and then a sequence of alternating rotations through gradually decreasing angles (to give the impression of the lifeboat almost capsizing and then righting itself). It will be appreciated that this sequence of events is given only by way of example, and indeed that the sequence would typically be varied between successive uses of the simulator 10. The motors 36 and the motors 26 would in practice be under automated control, for example using a computer, arranged to simulate a desired sequence of events.

For example, as an alternative, the lifeboat simulator 10 may be used to simulate the launching of a lifeboat by the traditional lowering technique. Again, the people to be trained would enter the cabin 12 through the hatch 14, and secure themselves to the seats where appropriate. In this case the cabin 12 would initially be horizontal. The pairs of motors 36 would then be actuated to give the people in the cabin 12 the impression that the cabin is being lowered, and the cabin 12 may not remain horizontal during that lowering process, and to give the impression that it then reaches the sea. The motors 36 and the motors 26 may then be actuated to simulate the effect that waves would have on the lifeboat.

It will be appreciated that the lifeboat simulator 10 is by way of example only, and that it may be modified in various ways while remaining within the scope of the present invention. For example the support pillars 32 may all be mounted on a turntable (not shown) so that the entire lifeboat simulator 10 described above can be turned to and fro about a vertical axis through at least a small angle, to subject the cabin 12 to yawing movements.

In a modification to the simulator 10, instead of supporting the bow support ring 22 by a pair of shafts 30, the opposed pivots 33 may instead be connected to a ring or C-shaped frame extending above the bow support ring 22, this being supported by a single shaft extending upward from its midpoint to a single motor on a mount directly above the centreline of the cabin 12; the same modification may be made to the support for the stern support ring 24. Alternatively but in an analogous fashion, the bow support ring 22 might instead be supported by connecting the opposed pivots 33 to a ring or C-shaped frame extending below the bow support ring 22, this being supported by a single shaft extending downward from its midpoint to a single motor directly below the centreline of the cabin 12; the same modification may be made to the support for the stern support ring 24. Where (as in the simulator 10) the support elements for both the bow support ring 22 and the stern support ring 24 extend in generally upward directions, then (as a further modification to the simulator 10) all the connections to the support pillars may be gimballed. But if both the bow support ring 22 and the stern support ring 24 are supported by mechanisms below the cabin 12, preferably only one such support mechanism is freely gimballed.

In an alternative, instead of using rigid shafts 30, the bow support ring 22 might instead be supported by cables connected to winch mechanisms mounted at the top of the support pillars 32; a limited degree of yawing motion can be brought about by actuating such a pair of winch mechanisms differently.

In another alternative the cabin 12 is supported within a single support ring, the support ring allowing rotation about the longitudinal axis of the cabin 12. Such a support ring may be structurally similar to the stern support ring 24 described above, for example in incorporating motors 26 to bring about such rotation. But in this case the pivots 33 would incorporate a drive mechanism to control the orientation of the support ring (and hence the cabin 12) relative to the support structure to which the pivots 33 are connected, to bring about pitching movements of the cabin 12.

What is claimed:

1. A lifeboat simulator, comprising a cabin to enclose at least one person, the cabin having a longitudinal axis, and the simulator comprising a support mechanism whereby the cabin can undergo at least limited rotational movement around its longitudinal axis, and can accelerate upwards and downwards, and can undergo pitch movements, all these movements being driven by one or more motors.

2. A lifeboat simulator as claimed in claim 1 also comprising means to subject the cabin to yawing movements.

3. A lifeboat simulator as claimed in claim 1, wherein the support mechanism comprises two spaced apart support frames which surround the cabin at different positions along its length and enable the cabin to undergo at least limited rotational movement about its longitudinal axis; and two height-adjustable support means to support the support frames, to enable the cabin to be subjected to accelerations in the upward or downwards direction, and to subject the cabin to pitching movements.

4. A lifeboat simulator as claimed in claim 3 wherein the height-adjustable support means comprise pillars provided with variable-length linkages.

5. A lifeboat simulator as claimed in claim 4 wherein the variable-length linkage associated with at least one support pillar is flexible.

6. A lifeboat simulator as claimed in claim 4 wherein the variable-length linkage associated with at least one support pillar comprises one or more rigid elements linked together and provided with pivotal connections.

7. A lifeboat simulator as claimed in claim 6 wherein at the least one variable-length linkage comprises a threaded shaft connected to the respective support frame by a pivot, and connected to the respective support pillar by a universal joint, and provided with a drive mechanism on the support pillar.

8. A lifeboat simulator as claimed in claim 3 wherein rotational movement of the cabin about its longitudinal axis is brought about by at least one motor associated with one of the support frames.

9. A lifeboat simulator as claimed in claims 1 also comprising means to damp movements of the cabin, so as to suppress oscillatory movements.
